(19) United States
(12) Patent Application Publication
(10) Pub. No.: US 2026/0340580 A1
(43) Pub. Date: Oct. 29, 2026

(54) SYSTEMS, METHODS, AND DEVICES FOR AI-ASSISTED INVENTORY MANAGEMENT WITH VOICE ASSISTANT AND IMAGE CAPTURE CAPABILITIES

(71) Applicants: Marion Gonzalez, Boerne, TX (US); Robert Gonzalez, Boerne, TX (US)

(72) Inventors: Marion Gonzalez, Boerne, TX (US); Robert Gonzalez, Boerne, TX (US)

(73) Assignee: Strinnova LLC, Boerne, TX (US)

(21) Appl. No.: 19/657,591

(22) Filed: Apr. 24, 2026

Related U.S. Application Data
(60) Provisional application No. 63/795,938, filed on Apr. 28, 2025.

(51) Int. Cl. G06Q 10/087; G06F 3/16; G06V 10/94; G06V 20/20; G06V 30/19

(52) U.S. Cl. CPC G06Q 10/08726; G06F 3/167; G06Q 10/08776; G06V 10/95; G06V 20/20; G06V 30/19

(57) ABSTRACT

A system for managing inventory includes a mobile computing device comprising a camera configured to capture images of labels associated with inventory items, a microphone, a speaker, and a display. A voice assistant module is configured to receive voice commands through the microphone and provide audio responses through the speaker, processing natural language commands related to inventory management tasks. A backend processing system in communication with the mobile computing device comprises an optical character recognition engine configured to process captured images and extract textual data from the labels, an artificial intelligence engine configured to enhance accuracy of data extraction, and an inventory database configured to store inventory data comprising product information and location identifiers. A labeling system comprises location labels, wherein each location label comprises a machine-readable code encoding a structured location identifier and a human-readable bin number derived from the structured location identifier.

### CROSS-REFERENCE TO RELATED APPLICATIONS

This application claims priority to U.S. Application No. 63/795938, filed Apr. 28, 2025, which is hereby incorporated by reference in its entirety.

### FIELD OF INVENTION

The present disclosure relates to inventory management systems, and more particularly to systems, methods, and devices for AI-assisted inventory management with voice assistant and image capture capabilities.

### BACKGROUND

Healthcare facilities, manufacturers, suppliers, and retailers face challenges in managing inventory, particularly when it comes to tracking expiration dates for medical supplies and devices, managing the location of items, and providing hands-free capabilities. Existing systems often rely on manual entry, RFID, barcode scanning, or closed cabinetry systems that can be time-consuming, error-prone, and difficult to use when healthcare professionals' hands are occupied.

In addition, current methods of location tracking often rely on manual entries or traditional barcodes, which may not provide real-time data or could be subject to human error. Inventory management in medical environments involves tracking numerous data points for each item, including manufacturer information, product identifiers, lot numbers, serial numbers, expiration dates, and storage locations. The complexity of managing this information across large facilities with multiple storage areas can lead to inefficiencies and inaccuracies.

Many existing inventory solutions lack integrated voice assistance, location identifiers, and seamless image recognition capabilities, which may enhance workflow efficiency, reduce errors, and support accurate inventory management. Healthcare professionals often have their hands occupied during patient care or while handling supplies, making traditional input methods inconvenient. Furthermore, the ability to quickly locate specific items within a facility and verify their expiration status remains a challenge with conventional systems.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a computer-implemented system for managing medical device inventory is provided. The system includes a mobile computing device equipped with a camera configured to capture high-resolution images of medical supply and device labels, a voice assistant module integrated with the device and capable of processing natural language commands for inventory management tasks, and a user interface that displays captured images, extracted data, and interactive prompts for user confirmation. The system further includes a backend processing system in operable communication with the mobile computing device. The backend processing system includes optical character recognition technology configured to process and analyze captured images to extract specific textual data including manufacturer name, product name, lot number, serial number, expiration date, and GTIN number. The backend processing system also includes artificial intelligence algorithms designed to enhance the accuracy of data extraction and provide context-based recommendations for inventory actions. The backend processing system further includes a centralized inventory database that stores and organizes extracted data, linking it with location identifiers such as floor number, room number, storage type, and bin number. The system includes a voice assistant module configured to interpret and respond to natural language commands related to inventory management, including adding new items, decrementing items from inventory, checking expiration dates, reordering supplies, and generating reports. The voice assistant module is further configured to provide real-time, context-sensitive feedback to the user, guiding them through inventory tasks such as replenishment, decrement, and item retrieval. The voice assistant module is configured to operate both online and offline, utilizing local processing capabilities for basic functions and server-based processing for more complex queries. The system includes a labeling and identification system comprising location labels with unique location/bin numbers and machine-readable codes, wherein each code encodes a structured location identifier comprising floor number, room number, storage type, row number, and positional reference, and wherein the bin number is derived based on the location identifier. The labeling and identification system further comprises product labels with standardized information for medical supplies and devices, which are captured and processed by the system to ensure accurate tracking. The system includes a notification and alert system integrated with the mobile computing device and configured to display augmented reality overlays on the device's screen to visually indicate inventory levels, expiration statuses, and specific storage locations. The notification and alert system is further configured to generate visual and audible alerts to notify users of critical inventory events, such as approaching expiration dates or successful data entries. The notification and alert system is configured to send automated reminders and reports to users based on predefined criteria, such as upcoming expirations or low stock levels.

According to other aspects of the present disclosure, the system may include one or more of the following features. The optical character recognition technology may be further configured to recognize and extract complex data from various label formats, including handwritten notes, barcodes, and mixed media labels. The optical character recognition technology may automatically correct errors in recognized text by cross-referencing extracted data with known product information stored in the inventory database. The voice assistant module may be further configured to interact with other voice-controlled devices within the facility's Internet of Things ecosystem, enabling coordinated inventory management across multiple platforms and devices. The voice assistant module may perform automated inventory tasks based on user-defined triggers or conditions, such as automatically reordering supplies when stock levels fall below a certain threshold, or generating alerts when items are nearing expiration. The voice assistant module may support multi-language functionality, allowing users to interact with the system in different languages. The system may further comprise an augmented reality interface, wherein the augmented reality interface overlays visual indicators on the device's display to highlight bins that require replenishment based on current inventory levels, color-code items based on their expiration status, and guide users to the exact location of a specified item within the storage facility utilizing visual cues and directional arrows. The backend system may be configured to retrieve the location identifier corresponding to a queried bin number and respond with either a condensed alphanumeric format or a descriptive textual format. The mobile computing device, upon scanning the machine-readable code, may retrieve both the encoded location identifier and inventory item metadata associated with the corresponding bin. The voice assistant module may interpret queries referencing bin numbers and provide real-time location details and augmented reality-enhanced visual guidance. Each individual component, including the voice assistant module, the optical character recognition subsystem, and the inventory database, may be implemented separately or in modular fashion, and may operate independently of one another while still performing inventory management functions. The system may further comprise a user account management module, wherein each user is associated with a set of permissions, notification preferences, and activity logs, and wherein account data is securely stored and synchronized via a remote server. The system may further comprise a user analytics module, wherein user-specific inventory interactions are recorded and analyzed to identify usage patterns, generate efficiency metrics, and provide data-driven insights into inventory behavior by time, location, or user role.

According to another aspect of the present disclosure, a method for managing medical device inventory is provided. The method includes capturing an image of a product label using a camera of a mobile computing device, wherein the image is processed by optical character recognition technology to extract relevant data. The method includes receiving a voice command through a voice assistant module to add or remove the product from the inventory, with the system processing the command and updating the inventory database accordingly. The method includes verifying and confirming the extracted data through a user interface, allowing the user to correct or approve the data before finalizing the inventory entry. The method includes generating an alert through a notification system if any discrepancies are detected during data entry, such as mismatched expiration dates or duplicate entries. The method includes displaying augmented reality overlays on the device's screen to assist the user in locating the appropriate storage bin for the product being managed.

According to other aspects of the present disclosure, the method may include one or more of the following features. The voice assistant module may provide real-time guidance during the inventory management process, including prompts for capturing additional data, reminders to verify product information, and suggestions for optimizing stock levels. The voice assistant module may respond to context-based queries and perform the requested action based on the latest inventory data. The method may further comprise deriving the bin number based on the structured location identifier encoded within the machine-readable code. The method may further comprise overlaying augmented reality visuals onto the physical location label in real-time upon scanning, including expiration status indicators, inventory levels, and storage confirmation. The method may further comprise using the voice assistant module to guide the user to or from a specific location or bin based on location or bin number, location metadata, or item metadata.

According to another aspect of the present disclosure, a method for associating a location identifier with an item is provided. The method includes generating a unique location identifier associated with a specific location. The method includes encoding the location identifier into a machine-readable code. The method includes printing the machine-readable code onto a label. The method includes attaching the label to the location where the item resides. The method includes scanning the machine-readable code using a scanning device. The method includes retrieving and displaying the location identifier of the item from the scanned machine-readable code.

According to other aspects of the present disclosure, the method may include one or more of the following features. The location identifier may include a physical location within a facility, a geographical coordinate, or a specific room or shelf number. The location identifier may be dynamically updated based on the movement or re-location of the item.

According to another aspect of the present disclosure, a system for location identification of items is provided. The system includes a location identifier generator for creating a unique location identifier. The system includes an encoder configured to encode the location identifier into a machine-readable code. The system includes a label printer for printing the machine-readable code onto a label. The system includes a scanner for scanning the machine-readable code. The system includes a display device for displaying the location of the item based on the scanned machine-readable code.

According to other aspects of the present disclosure, the scanner may be a mobile phone or handheld scanning device that includes a camera for scanning the machine-readable code.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a system for inventory management, according to an embodiment.

FIG. 2A illustrates a flowchart of a workflow process for managing inventory, according to an embodiment.

FIG. 2B illustrates a continuation of the flowchart of FIG. 2A depicting a voice command path and an optical character recognition path, according to an embodiment.

FIG. 2C illustrates a continuation of the flowchart of FIG. 2A depicting a confirmation and completion workflow, according to an embodiment.

FIG. 3A illustrates a flowchart of a method for location labeling of inventory items, according to an embodiment.

FIG. 3B illustrates a continuation of the flowchart of FIG. 3A depicting scanning and querying of location labels, according to an embodiment.

FIG. 4 illustrates a system for tracking and updating inventory replenishment, according to an embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The present disclosure relates to inventory management, and more specifically to systems, methods, and devices for assisting in locating items for fast retrieval and managing inventory data. Embodiments manage inventory using any combination of artificial intelligence, voice assistant technology, and image capture capabilities to facilitate item location, data extraction, and inventory updating. In some aspects, the subject technology may be used for the pharmaceutical, medical supply, and device industry, but may also be used in other fields that manage inventory.

It should be appreciated that aspects of the subject technology are beyond mere retrieval and presentation of information. Features of the subject technology improve on network-based inventory systems by connecting end users to the current status and location of items in the system. In many instances, the end user is physically far from an item of need and for the sake of efficiency, wishes to know an item's availability and location before searching any one of multiple possible buildings and rooms for the item. In the context of medical supplies, the need to confirm availability and location is important for the well-being of patients that may be in expedient need of the item. Thus, the system's features that use AI, OCR, and processes that identify an item by label, its location, and inventory count, provide a practical application of the underlying concepts in that combinations of the features cooperate to ultimately provide end users with the item using electronic means thereby increasing the health or general well-being of a person. Moreover, a voice assistant provides users with a quick and convenient interface that can help speed up the item location and availability confirmation as well as a guided path to the item's specific location.

In some aspects, an inventory management system may integrate voice assistant functionalities to locate inventory, including items with and without expiration dates, within healthcare facilities or other locations storing items with medical labels and expiration dates. The system may include mobile computing devices equipped with cameras to capture images of medical labels, which may be processed using optical character recognition (OCR) and artificial intelligence (AI) to extract relevant data such as expiration dates, product identifiers, and other information.

In some aspects, a voice assistant module may enable hands-free operation, allowing users to manage inventory tasks through natural language commands. The voice assistant module may interpret and respond to natural language commands related to inventory management, including adding new items, decrementing items from inventory, checking expiration dates, reordering supplies, and generating reports. The voice assistant module may provide real-time, context-sensitive feedback to the user, guiding the user through inventory tasks such as replenishment, decrement, and item retrieval.

In some aspects, the system may include augmented reality (AR) visual aids and automated notifications to assist users in locating items, checking expiration statuses, and performing inventory actions. The system may include a labeling and identification mechanism comprising location labels with unique location/bin numbers and machine-readable codes, wherein each code encodes a structured location identifier comprising floor number, room number, storage type, row number, and positional reference, and wherein the bin number may be derived based on the location identifier.

In some aspects, the system may include a backend processing system comprising optical character recognition technology configured to process and analyze captured images to extract specific textual data including manufacturer name, product name, lot number, serial number, expiration date, and GTIN number. The backend processing system may also include artificial intelligence algorithms designed to enhance the accuracy of data extraction and provide context-based recommendations for inventory actions. The backend processing system may further include a centralized inventory database that stores and organizes extracted data, linking the extracted data with location identifiers such as floor number, room number, storage type, and bin number.

In some aspects, the system may be designed for integration with existing healthcare infrastructure, providing a solution to improve inventory accuracy, reduce errors, and enhance overall efficiency in medical environments.

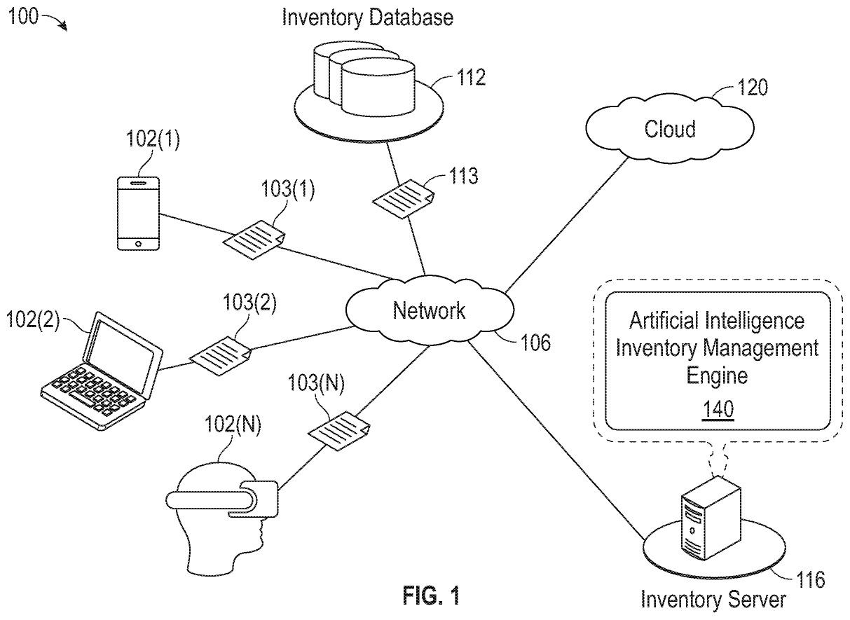

Referring to FIG. 1, a system 100 for inventory management is shown according to an embodiment. The system 100 may integrate advanced technologies such as optical character recognition (OCR), artificial intelligence (AI), and voice assistants to provide a solution for inventory control. The system 100 may include multiple mobile computing devices 102(1), 102(2), through 102(N), a network 106, an inventory database 112, an inventory server 116, and a cloud 120.

The mobile computing devices 102(1), 102(2), 102(N) may be smartphones, tablets, wearable technology such as smart glasses, smart watches, virtual reality/augmented reality/mixed reality devices including headsets, or other handheld or portable electronic devices equipped with image-capturing capabilities and processing power. Each mobile computing device 102(1), 102(2), 102(N) may be equipped with a high-resolution camera configured to capture images of medical supply and device labels. Each mobile computing device 102(1), 102(2), 102(N) may include an interactive visual display that provides a user interface for users to interact with the system 100, confirm data entries, and receive visual cues and notifications. Each mobile computing device 102(1), 102(2), 102(N) may further include a speaker and a microphone to support voice assistant functionalities for hands-free operation. In some embodiments, one or more of the mobile computing devices 102(1), 102(2), to 102(N) may be an augmented reality (AR) device (for example, as illustrated as mobile computing device 102(N), equipped with a digital display configured to generate a replicated digital scene in the display. In some embodiments, the AR device is configured to display a mixed reality scene that shows digital elements overlaying a real-life scene.

With continued reference to FIG. 1, each mobile computing device 102(1), 102(2), 102(N) may include at least a processor that coordinates data intake and transmission between other elements in the mobile computing device 102(1), 102(2), 102(N). Each mobile computing device 102(1), 102(2), 102(N) may provide visual and audible indicators for confirmation purposes when using the system 100. For example, a visual indicator may be a prompt on the interactive visual display confirming a user action. An audible indicator may include a bell chime that is output from the mobile computing device 102(1), 102(2), 102(N) to confirm an action such as adding an item to inventory. The visual and audible indicators may be used together, individually, or not at all.

Each mobile computing device 102(1), 102(2), 102(N) is connected to the network 106 via respective network connections 103(1), 103(2), and 103(N). The network 106 serves as a communication hub that facilitates data exchange between the various components of the system 100. The network 106 topology allows the mobile computing devices 102(1), 102(2), 102(N) to communicate with the inventory database 112 and the inventory server 116, enabling users to perform inventory management tasks such as adding items, removing items, checking expiration dates, and locating supplies through voice commands or image capture.

As further shown in FIG. 1, the inventory database 112 is connected to the network 106 via a database connection 113. The inventory database 112 stores comprehensive information about inventory items, including product details and location identifiers. The inventory database 112 may include a location mapping module that maintains data on storage locations within a facility, including floor number, room number, storage type, row number, positional reference in a bin, shelf or other storage device, and bin numbers. The database connection 113 enables the mobile computing devices 102(1), 102(2), 102(N) to access and update inventory data stored in the inventory database 112.

The inventory server 116 is in communication with the network 106 and hosts an artificial intelligence inventory management engine 140. The artificial intelligence inventory management engine 140 employs AI algorithms to enhance data processing accuracy, interpret complex information, and facilitate intelligent voice assistant interactions. The artificial intelligence inventory management engine 140 may process data extracted from captured images using optical character recognition and may provide context-based recommendations for inventory actions. The optical character recognition technology may be configured to process and analyze captured images to extract specific textual data including manufacturer name, product name, lot number, serial number, expiration date, and GTIN number.

The artificial intelligence inventory management engine 140 may be customized to factor in different dialects, accents, languages, and other linguistic differences to ensure that the system 100 may be used in various locations. The artificial intelligence inventory management engine 140 may be trained on medical and pharmaceutical supply jargon, including language present on medical and pharmaceutical supply labels, and may be further tailored to institution-specific items and jargon to enhance efficiency at a specific institution. Data collected by the system 100 may be fed into the artificial intelligence inventory management engine 140 to help users make informed decisions, such as suggestions for changing stock levels, determining when to reorder items based on historical usage and current inventory levels, or changing item locations based on usage patterns.

With continued reference to FIG. 1, the system 100 includes a voice assistant module that may integrate with existing voice assistant platforms such as Siri, Alexa, Google Assistant, or custom AI-driven voice assistants. The voice assistant module may include a natural language processing (NLP) engine that understands and processes user voice commands for various inventory management tasks. The NLP engine may provide real-time feedback, guidance, and notifications to users based on voice interactions. For example, in response to a user query to locate an item from inventory, the NLP engine may provide a verbal description of the item's location including a room number, a shelf number, and a bin number, and may provide a quantity of the item remaining in stock. As the user enters the room, the NLP engine may be configured to provide a map and using real-time location data, guide the user to the shelf and bin number holding the item requested. The voice assistant module may operate both online and offline, utilizing local processing capabilities for basic functions and server-based processing for more complex queries.

The cloud 120 is connected to the network 106 and provides additional storage and processing capabilities. The cloud 120 enables remote access to system resources and supports data synchronization across multiple devices. The system 100 may be designed for integration with existing healthcare infrastructure to provide efficient and accurate inventory control.

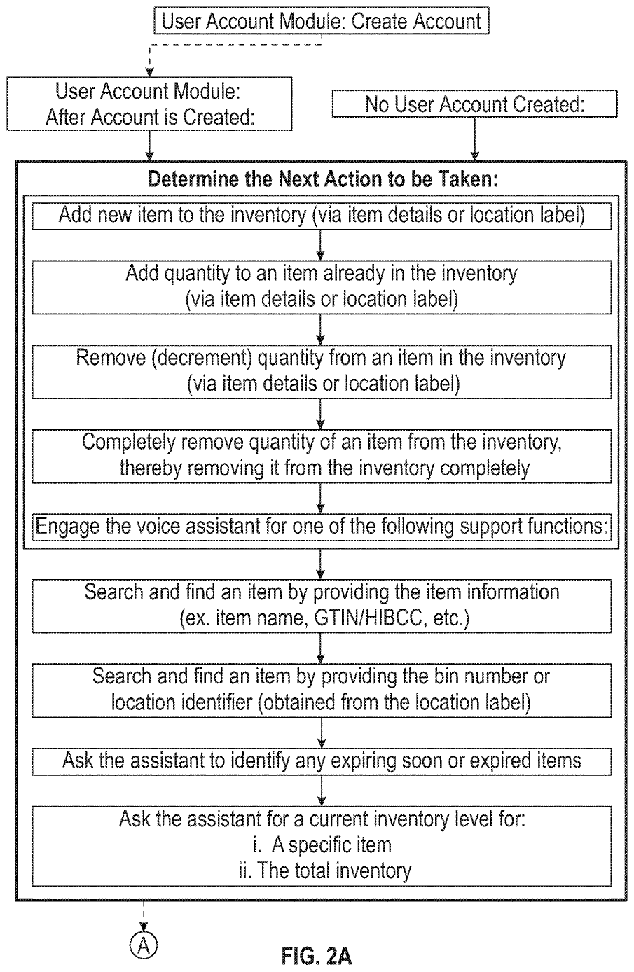

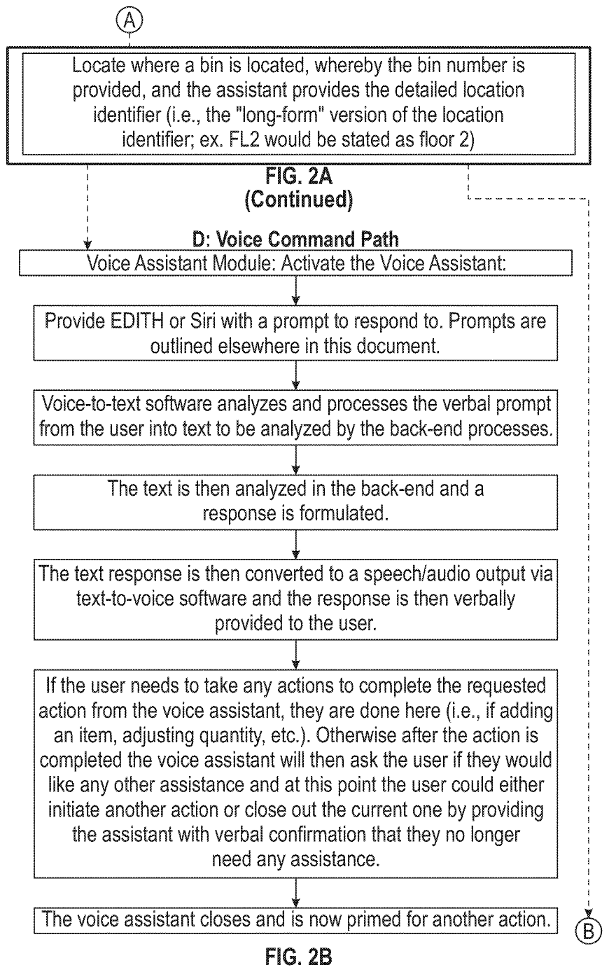

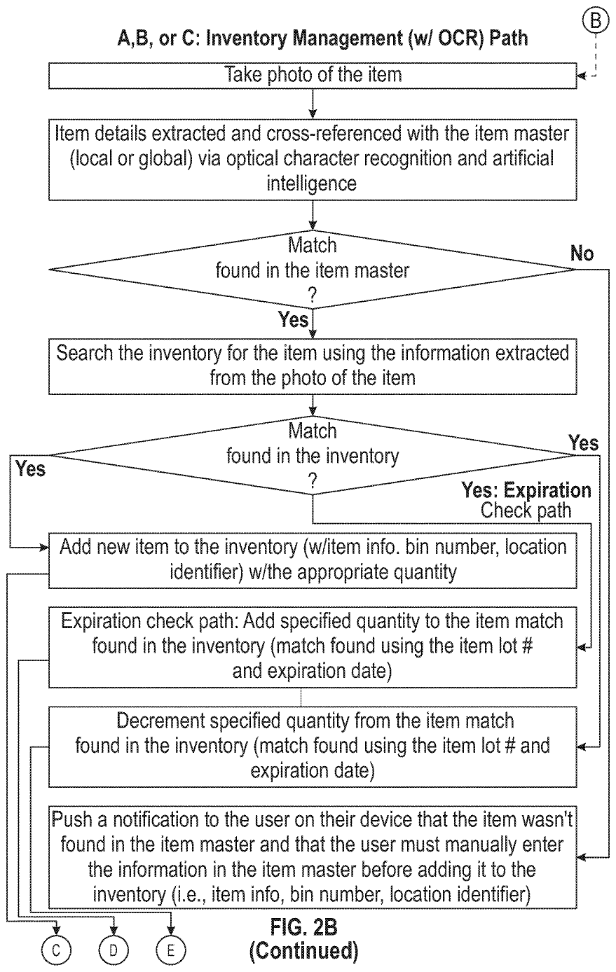

Referring to FIG. 2A, a workflow process for managing inventory using electronic item location and inventory updating is shown according to an embodiment. The workflow process may begin with a user account module that provides account creation and authentication functionality for users of the system 100.

In some aspects, the user account module may allow a user to create an account by opening an application on a mobile computing device 102(1), 102(2), 102(N) and selecting a create account option. The user may enter personal information, select an institution name from a dropdown menu, and generate a username and password. Upon selecting a completion option, the system 100 may send an email to the user with instructions to verify the account. The user may follow the instructions to complete account creation in the system 100.

With continued reference to FIG. 2A, after an account has been created, the user may open the application and select a sign-in option. The user may enter the username and password for the account and select a sign-in button to authenticate and access the application. In some aspects, the system 100 may allow users to access the application without creating an account by selecting a no account option, which opens the application without user authentication.

The workflow process proceeds to a decision point for determining a next action to be taken. From the decision point, the workflow branches into multiple possible actions that a user may select for inventory management. A first action involves adding a new item to the inventory via item details or a location label. A second action involves adding quantity to an item already in the inventory via item details or a location label. A third action involves removing or decrementing quantity from an item in the inventory via item details or a location label. A fourth action involves completely removing quantity of an item from the inventory, thereby removing the item from the inventory completely. As will be understood, while the actions above were characterized as a user performing the actions, in other embodiments, these actions may be characterized as one or more processors in the inventory server 116 receiving the input or performing the action.

As further shown in FIG. 2A, the workflow process includes a feature to operate a voice assistant module for engagement by the user of one or more support functions. The support functions may include searching and finding an item by providing item information such as an item name, a Global Trade Item Number (GTIN), or a Health Industry Bar Code (HIBCC). Another support function involves searching and finding an item by providing a bin number or location identifier obtained from a location label. A further support function includes receiving by the voice assistant module, a request to identify any items that are expiring soon or have expired. Additionally, the voice assistant module may be configured to provide a current inventory level for a specific item or for the total inventory based on data in the database 112. The voice assistant module provides may also be configured to provide a bin location determination, whereby the voice assistant module provides the detailed location identifier in a long-form version, such as stating FL2 as Floor 2.

In some aspects, the system 100 may include a user account management module, wherein each user is associated with a set of permissions, notification preferences, and activity logs. Account data may be securely stored and synchronized via a remote server. The user account management module may support secure user login functionality, allowing individuals to access inventory features based on assigned roles or permissions.

In some aspects, the system 100 may include a user analytics module that records and analyzes user-specific inventory interactions. Actions performed by users, such as adding, removing, or querying items, may be logged with timestamps, location identifiers such as bin number or room number, or a unique identifier to track user behavior. The user analytics module may analyze user-specific actions to detect trends such as frequency of item retrievals by time of day or user, whether items are consistently pulled before expiration, and which users or departments are contributing to reducing waste or preventing expirations. The user analytics module may generate efficiency metrics and provide data-driven insights into inventory behavior by time, location, or user role. These analytics may be used to generate personalized or institutional reports that optimize workflows, reduce unnecessary stock usage, and support budget-saving initiatives.

Referring to FIG. 2B, a voice command path and an optical character recognition (OCR) path for the inventory management workflow are shown according to an embodiment. FIG. 2B illustrates a continuation of the workflow process from FIG. 2A, depicting the processing paths that enable users to interact with the system 100 through voice commands and image capture.

In some aspects, the voice command path may begin with activation of a voice assistant module on a mobile computing device 102(1), 102(2), 102(N). The voice assistant module may integrate with existing voice assistant platforms such as Siri, Alexa, Google Assistant, or custom AI-driven voice assistants. Upon activation, the user may provide the voice assistant module with a verbal prompt related to an inventory management task.

The voice command path may include voice-to-text processing, wherein voice-to-text software analyzes and processes the verbal prompt from the user into text. The text may be transmitted to a backend processing system for analysis. The backend processing system may analyze the text and formulate a response based on data stored in the inventory database 112 and processing performed by the artificial intelligence inventory management engine 140.

In some aspects, the backend processing system may convert the text response to a speech or audio output via text-to-voice software. The response may then be verbally provided to the user through a speaker of the mobile computing device 102(1), 102(2), 102(N). If the user needs to take any actions to complete the requested action from the voice assistant module, such as adding an item or adjusting quantity, the user may perform the actions at this point. After the action is completed, the voice assistant module may ask the user if the user would like any other assistance. The user may either initiate another action or close out the current action by providing the voice assistant module with verbal confirmation that the user no longer needs any assistance. The voice assistant module may then close and be primed for another action.

As further shown in FIG. 2B, the voice assistant module may provide real-time feedback, guidance, and notifications to users based on voice interactions. For example, in response to a user query to locate an item from inventory, the voice assistant module may provide a verbal description of the item's location including a room number, a shelf number, and a bin number, and may provide a quantity of the item remaining in stock. The voice assistant module may also determine a bin location, whereby the bin number is provided and the voice assistant module provides the detailed location identifier in a long-form version, such as stating FL2 as Floor 2.

In some aspects, the voice assistant module may operate both online and offline. The voice assistant module may utilize local processing capabilities for basic functions and server-based processing for more complex queries. Basic voice assistant functionalities may operate without internet connectivity, ensuring uninterrupted service in environments where network access may be limited.

In some aspects, the voice assistant module may proactively notify users about inventory events without prompts. For example, the voice assistant module may provide an alert such as “Alert: Stock level of Item M has fallen below the minimum threshold. Recommend reordering 50 units.” The voice assistant module may perform automated inventory tasks based on user-defined triggers or conditions, such as automatically reordering supplies when stock levels fall below a threshold, or generating alerts when items are nearing expiration.

With continued reference to FIG. 2B, the voice assistant module may include settings that are customizable for language preferences, notification types, and integration with other systems. The artificial intelligence inventory management engine 140 may be customized to factor in different dialects, accents, languages, and other linguistic differences to ensure that the system 100 may be used in various locations. The artificial intelligence inventory management engine 140 may be trained on medical and pharmaceutical supply jargon, including language present on medical and pharmaceutical supply labels, and may be further tailored to institution-specific items and jargon.

Referring again to FIG. 2B, the OCR path may begin with a photo of an item being captured by a camera of a mobile computing device 102(1), 102(2), 102(N). The system 100 may extract item details from the captured image and cross-reference the extracted details with an item master database using optical character recognition and artificial intelligence technologies. The item master database may be a local database (for example, database 112) or a global database accessible via the network 106.

In some aspects, the OCR technology may be configured to recognize and extract complex data from various label formats, including handwritten notes, barcodes, and mixed media labels. The OCR technology may process captured images to extract specific textual data including manufacturer name, product name, lot number, serial number, expiration date, manufacture date, Global Trade Item Number (GTIN), package quantity, reference or catalog number, and storage and handling instructions.

As further shown in FIG. 2B, the OCR technology may automatically correct errors in recognized text by cross-referencing extracted data with known product information stored in the inventory database 112. The artificial intelligence inventory management engine 140 may enhance the accuracy of OCR when analyzing, processing, and extracting complex information from labels on medical and pharmaceutical supplies.

In some aspects, the OCR path may proceed to a decision point that determines whether a match is found in the item master database. If no match is found, the system 100 may push a notification to the user on the mobile computing device 102(1), 102(2), 102(N) indicating that the item was not found in the item master database and that the user must manually enter the information in the item master database before adding the item to the inventory. The manual entry may include item information, bin number, and location identifier.

If a match is found in the item master database, the system 100 may search the inventory database 112 for the location(s) of the item using the information extracted from the photo of the item. The system 100 may then determine whether a match is found in the inventory database 112.

In some aspects, if a match is found in the inventory database 112, the system 100 may add a new item to the inventory with item information, bin number, and location identifier, along with the appropriate quantity. Alternatively, the system 100 may add a specified quantity to an item match found in the inventory database 112, where the match is found using the item lot number and expiration date. The system 100 may also decrement a specified quantity from an item match found in the inventory database 112, again using the item lot number and expiration date for matching.

In some aspects, the extracted information may be cross-referenced with existing entries in the inventory database 112 to locate the exact item record. If no matching record is found in the inventory database 112, the system 100 may prompt the user to verify the information or may provide options to create a new entry. The extracted product information may be linked with corresponding location information to create a comprehensive inventory entry. In some embodiments, using either OCR or AI, or a combination of the two, the system is configured to recognize the active ingredient of a drug (provided by the label via OCR and analyzed by the AI algorithm cross-referencing the active ingredient across brand and generic names) and provide similar matches whether or not a matching record is found in the database. Since brand name and generic name drugs differ in some ways (including but not limited to, fillers and dyes, tablet/pill shape and color, packaging details), the system may be configured to prompt the user to examine the packaging and label prior to adjusting inventory levels (e.g. adding/decrementing inventory or creating a new listing). Although similar, the system may recommend generating a new entry for generic and brand name drugs, for example, because of the above mentioned differences. When creating a new entry for an item not found, if the queried item is similar, the system can recommend a location for the new item based on the location(s) of similar items to make future retrieval easier. As may be appreciated, the placement of this new item may be used for analytics purposes to compare usage between brand and generic name drugs. This may be presented as a recommendation with the user having to confirm and finalize the new entry (item information and location information).

Referring to FIG. 2C, a confirmation and completion workflow for the inventory management system 100 is shown according to an embodiment. FIG. 2C illustrates a continuation of the workflow process from FIGS. 2A and 2B, depicting the processing paths that enable users to verify and finalize inventory actions through visual feedback and user confirmation.

In some aspects, the mobile computing device 102(1), 102(2), 102(N) may provide visual feedback to the user regarding an action to be undertaken. For example, a popup window may appear on the user interface displaying item information for a new item to be added to the inventory. The popup window may present consolidated data including manufacturer name, product name, lot number, expiration date, bin number, location identifier, and quantity. The user may then confirm whether the action is correct and whether the application should proceed with the action.

With continued reference to FIG. 2C, the workflow may branch based on whether the item information displayed in the popup window is correct. In a first path, when the item information is correct, the system may receive a confirmation of the action to be undertaken by registering the press of a confirmation button on the user interface. Following the confirmation, the system 100 may complete the action and update the inventory database 112 accordingly.

In a second path, a manual edit of the item information may be received in the popup window before confirming the action. The user interface may provide buttons and/or fields configured for the user to correct or modify any discrepancies in the extracted data, such as adjusting quantity values, correcting lot numbers, or updating expiration dates. After making any edits, the user may confirm the action by pressing the confirmation button, and the system 100 may complete the action with the edited information.

As further shown in FIG. 2C, upon completion of the action, the system 100 may provide an audible cue to indicate that the action has been completed. The audible cue may be a bell chime, tone, or other sound notification output from the mobile computing device 102(1), 102(2), 102(N). Following the audible confirmation, the application may return to a home view and may be primed for another action. The combination of visual feedback through the popup window and audible confirmation upon completion may facilitate efficient sequential processing of multiple inventory items.

In some aspects, the artificial intelligence inventory management engine 140 may analyze data collected by the system 100 to provide inventory suggestions based on usage patterns. Data on item usage rates may be fed into the artificial intelligence inventory management engine 140, and the system 100 may generate suggestions including changing stock levels of items, determining when to reorder items based on historical usage and current inventory levels, changing item locations if usage appears to be declining, and removing items from the inventory if depressed usage persists for a period of time. The artificial intelligence inventory management engine 140 may provide context-based recommendations for inventory actions based on the analyzed data.

With continued reference to FIG. 2C, the system 100 may include a task automation module that facilitates automated actions based on user-defined triggers or conditions. The task automation module may perform automated inventory tasks such as automatically reordering supplies when stock levels fall below a threshold, generating alerts when items are nearing expiration, generating reports, and setting reminders. For example, the voice assistant module may proactively notify users about inventory events without prompts, such as providing an alert stating that a stock level of a particular item has fallen below a minimum threshold and recommending reordering a specified quantity.

In some aspects, the task automation module may interact with other voice-controlled devices within a facility's Internet of Things (IoT) ecosystem, enabling coordinated inventory management across multiple platforms and devices. The task automation module may generate automated reminders and reports to users based on predefined criteria, such as upcoming expirations or low stock levels. The automated reminders may notify users of upcoming expiration dates and necessary inventory actions, while report generation may create and share detailed reports on inventory status, usage trends, and expiration data.

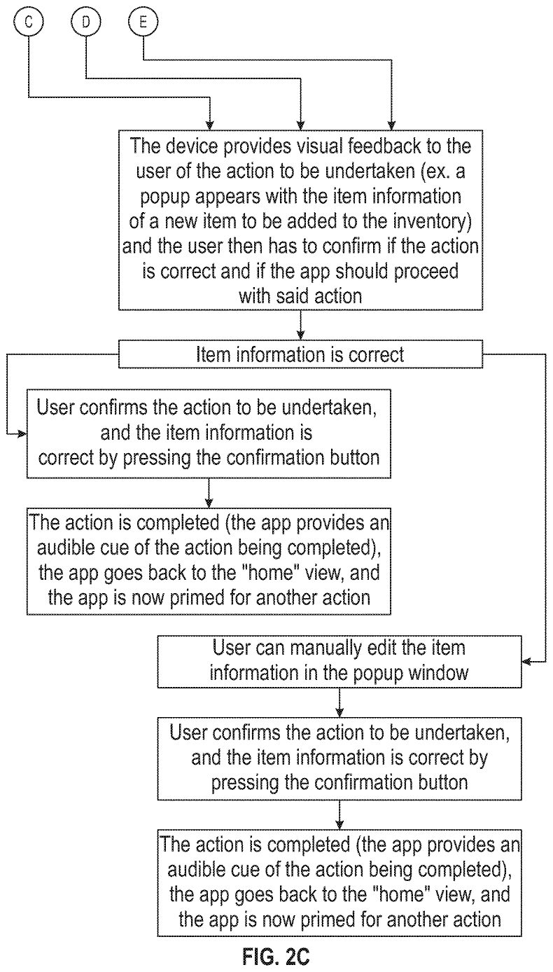

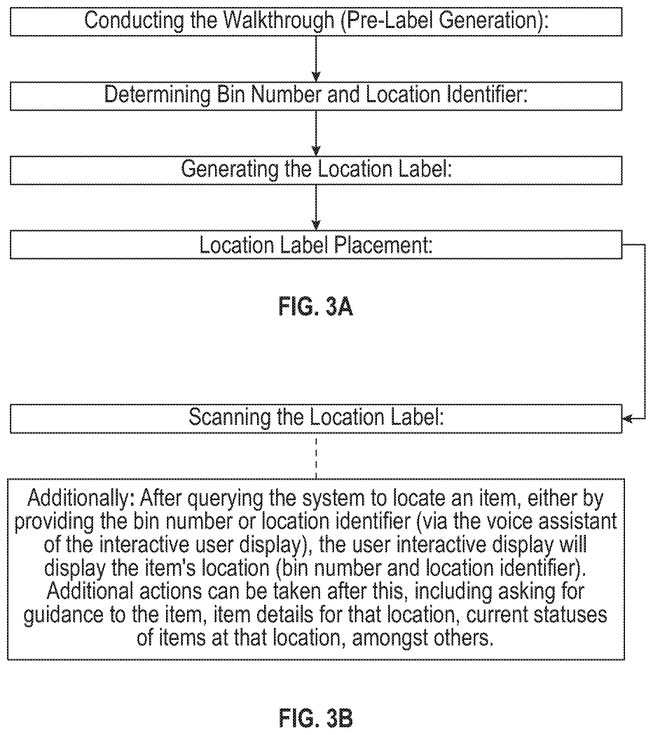

Referring to FIGS. 3A and 3B, a method for location labeling of inventory items is shown according to an embodiment. The method may include a pre-label generation phase, a label generation phase, a label placement phase, and a scanning and retrieval phase.

In some aspects, the pre-label generation phase may begin with conducting a walkthrough at a facility to survey the facility's inventory. During the walkthrough, a determination may be made regarding which items are to be managed under the system 100. The walkthrough may involve identifying storage locations throughout the facility, including bins, wire shelves, cabinets, and other storage areas where inventory items reside.

With continued reference to FIG. 3A, after determining which items are to be managed, the method may proceed to determining a bin number and a location identifier. The location identifier may be determined based on the physical location of the item to be managed. The location identifier may be established based on factors including a floor number, a room number, a storage type, a row number, and a position number. After the location identifier is determined, the bin number may be determined based on the location identifier and user discretion. The bin number may serve as a condensed reference that corresponds to the full location identifier stored in the inventory database 112.

In some aspects, the method may proceed to generating the location label. During label generation, the location identifier may be encoded into a machine-readable format. The machine-readable format may include a QR code, a DataMatrix, a barcode, an NFC tag, or other machine-readable label or apparatus. The encoded information may be printed onto a label or may be created using a generator and then transferred to the label apparatus.

As further shown in FIG. 3A, the method may include location label placement. The location label may be affixed to the item location, such as a bin or shelf, for easy viewing and retrieval. The label may be attached to the storage location to ensure that the location is visually marked with the location identifier.

Referring to FIG. 3B, the method may include scanning the location label. When the machine-readable portion of the location label is scanned using a mobile computing device 102(1), 102(2), 102(N), the mobile computing device 102(1), 102(2), 102(N) may load item metadata and location information including the bin number and the location identifier. Upon scanning the machine-readable portion of the location label, a user may opt to adjust inventory by adding or removing items, view item details for the bin, view expiration statuses of items in the bin, or perform other actions.

In some aspects, each location label may comprise a dual-format configuration including both a machine-readable code and a human-readable bin number. The machine-readable code may encode a structured location identifier that includes a floor number (FL#), a room number (RM#), a storage type (ST#), a row number (ROW#), and a positional reference (POS#). The bin number may be derived based on the structured location identifier. The dual-format configuration may allow users to reference the bin number visually while also enabling automated data retrieval through scanning.

With continued reference to FIG. 3B, the system 100 may support multiple location format options for communicating location information to users. When a user requests the location of a specific bin number, a backend processing system may search the inventory database 112 for the associated location identifier. The backend processing system may communicate the location to the user in either a condensed alphanumeric format (such as FL2-RM105-ST1-ROW3-POS2) or an expanded descriptive textual format (such as Floor 2, Room 105, Storage Type 1, Row 3, Position 2). The voice assistant module may provide the detailed location identifier in a long-form version, such as stating FL2 as Floor 2.

In some aspects, the location identifier may be dynamically updated based on the movement or relocation of an item. When an item is moved from one storage location to another, the system 100 may update the location identifier associated with the item in the inventory database 112. The location identifier may include a physical location within a facility, a geographical coordinate, or a specific room or shelf number.

In embodiments using augmented reality (AR) based user interfaces, the system 100 may include AR overlay indicators that provide visual cues through the display of a mobile computing device 102(1), 102(2), 102(N). The AR overlays may indicate inventory levels, expiration statuses, storage locations, and item information. Upon scanning a location label, the system 100 may overlay AR visuals onto the physical location label in real-time, including expiration status indicators, inventory levels, and storage confirmation.

As further shown in FIG. 3B, the system 100 may include AR expiration color coding to visually communicate the expiration status of items. The AR interface may color-code items based on expiration status. For example, items expiring in over 90 days may be displayed in green, items expiring in 30-90 days may be displayed in yellow, and items expiring in under 30 days may be displayed in red. The color coding may allow users to quickly identify items that require attention due to approaching expiration dates.

In some aspects, the system 100 may include AR directional guidance to assist users in locating items within a storage facility. The AR interface may guide users to the exact location of a specified item within the storage facility utilizing visual cues and directional arrows. The AR interface may highlight bins that require replenishment based on current inventory levels.

With continued reference to FIG. 3B, the system 100 may provide navigational assistance through the voice assistant module. After querying the system 100 to locate an item by providing the bin number or location identifier via the voice assistant module or an interactive user display, the mobile computing device 102(1), 102(2), 102(N) may display the item's location including the bin number and location identifier. The voice assistant module may recognize bin numbers and provide responses based on the linked location identifier. For example, users may ask questions such as “Where is Bin 27?” and receive guided instructions or descriptive location responses. The voice assistant module may guide the user to or from a specific location or bin based on location or bin number, location metadata, or item metadata.

In some aspects, the system 100 may support image-based location inference. When a user captures an image of a product without prior location identification, the system 100 may analyze the product image and match the product image with existing inventory entries to infer the appropriate storage location based on historical data. The user may confirm the suggested location, and the system 100 may update the inventory database 112 accordingly.

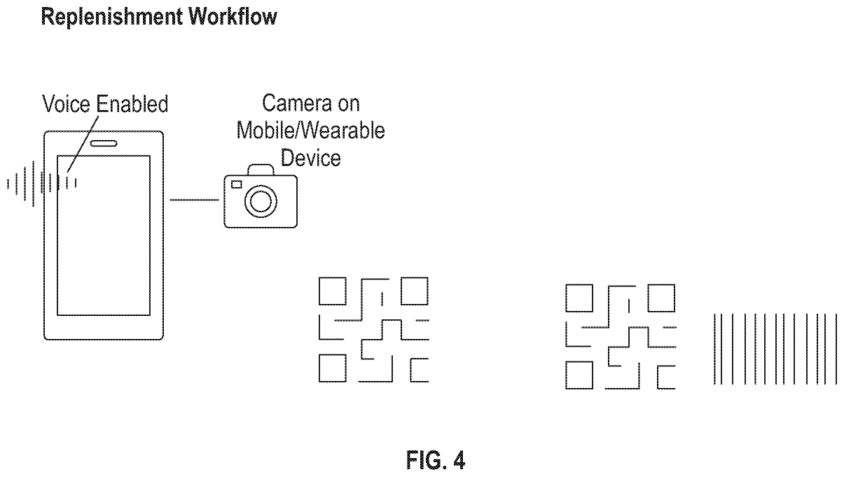

Referring to FIG. 4, a system for tracking and updating inventory replenishment is shown according to an embodiment. The system may facilitate efficient and accurate addition of new inventory items through the coordinated use of voice interaction and image capture capabilities.

In some aspects, the system may include a voice enabled mobile computing device connected to a camera. The mobile computing device may be a smartphone, tablet, wearable device such as smart glasses, or other handheld electronic device equipped with image-capturing capabilities and processing power. The camera may be configured to capture images of labels and codes associated with inventory items during a replenishment workflow. The voice enabled functionality may allow users to interact with the system 100 through natural language commands, such as initiating replenishment tasks by issuing voice commands to add items to specific bin locations.

The system may process multiple types of machine-readable codes during the replenishment workflow. The examples shown include a QR code and a bar code. The QR code may encode location-specific data including structured location identifiers such as floor number, room number, storage type, row number, and positional reference. A barcode may provide an alternative machine-readable format that the system may process. The camera may capture images of the machine-readable codes, and the system may process the captured information to extract location data and product details. The system may also process DataMatrix codes, NFC tags, or other machine-readable labels or apparatus. It will be understood that the code types shown are for illustrative purposes and other code types may be used without departing from the scope of the subject technology.

In some aspects, during the replenishment workflow, a user may access an inventory management application on the mobile computing device 102(1), 102(2), 102(N) through a user interface. The application interface may be ready for data entry, with the camera activated for image capture. The user may capture an image of a location label including a bin number where an inventory item is to be stored. The system may process the captured image using optical character recognition to extract location information via the bin number, which on a backend corresponds to a location identifier that includes floor number, room number, storage type, row number, and position number.

As further shown in FIG. 4, the user may capture an image of a product label on a medical supply or device using the camera. The system 100 may employ optical character recognition and artificial intelligence technologies to extract product information including manufacturer name, product name, lot number, serial number, expiration date, manufacture date, Global Trade Item Number (GTIN), package quantity, reference or catalog number, and storage and handling instructions. The extracted product information may be linked with corresponding location information to create a comprehensive inventory entry.

In some aspects, the system 100 may be designed to integrate with existing inventory management and supply chain systems within healthcare facilities. The system 100 may integrate with Enterprise Resource Planning (ERP) systems such as Lawson, SAP, and Oracle for synchronized data management. The system 100 may provide direct connectivity to Material Management Information Systems (MMIS) for real-time updates and data consistency. The system 100 may also integrate with Electronic Health Records (EHR) to link inventory usage directly with patient care records for comprehensive tracking.

With continued reference to FIG. 4, the system 100 may include integration mechanisms for data synchronization with existing platforms. The system 100 may utilize Application Programming Interfaces (APIs) to enable real-time data exchange between the inventory management system and existing platforms. Data mapping and transformation processes may ensure that data formats are compatible across different systems. Inventory changes may be automatically reflected across all connected systems, reducing manual data entry and errors.

In some aspects, the system 100 may support Single Sign-On (SSO) mechanisms for seamless and secure user authentication across multiple systems. The system 100 may employ data encryption and security measures to protect sensitive inventory and patient data during transmission and storage. The security protocols may ensure that data exchanged between the mobile computing devices 102(1), 102(2), 102(N), the inventory database 112, and the inventory server 116 remains protected.

In some aspects, the system 100 may include a modular architecture that allows for modular integration, enabling facilities to implement components that fit existing infrastructure and needs. The modular architecture may accommodate growth and expansion by integrating additional modules or connecting with new systems as required. The voice assistant module, the optical character recognition subsystem, and the inventory database 112 may be implemented separately or in modular fashion, and may operate independently of one another while still performing inventory management functions.

As further shown in FIG. 4, the voice assistant module may interact with other voice-controlled devices within a facility's Internet of Things (IoT) ecosystem, enabling coordinated inventory management across multiple platforms and devices. The voice assistant module may perform automated inventory tasks based on user-defined triggers or conditions, such as automatically reordering supplies when stock levels fall below a threshold, or generating alerts when items are nearing expiration. The IoT integration may allow the system 100 to coordinate with connected devices throughout a healthcare facility for comprehensive inventory tracking and management.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. The eNB (or other base station) and UE (or other mobile station) may also include a transceiver component, a counter component, a processing component, and/or a clock component or timer component. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or an interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present invention. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein, but may be modified within the scope and equivalents of the appended claims.

Those having skill in the art will appreciate that many changes may be made to the details of the above-described embodiments without departing from the underlying principles of the invention. The scope of the present invention should, therefore, be determined only by the following claims.

1. A system for managing inventory, the system comprising:
a mobile computing device comprising a camera configured to capture images of labels associated with inventory items, a microphone, a speaker, and a display; and
a backend processing system in communication with the mobile computing device, the backend processing system comprising:
a computer server operating an optical character recognition engine configured to process captured images and extract textual data from the labels;
an inventory database configured to store inventory data comprising product information and location identifiers associated with the inventory items;
an artificial intelligence engine configured to identify individual items from the inventory database based on data extraction performed by the optical character recognition engine; and
a labeling system comprising location labels, wherein each location label comprises a machine-readable code encoding a structured location identifier and a bin number derived from the structured location identifier.

2. The system of claim 1, wherein the structured location identifier comprises a floor number, a room number, a storage type, a row number, and a positional reference.

3. The system of claim 1, wherein the textual data extracted by the optical character recognition engine comprises at least one of a manufacturer name, a product name, a lot number, a serial number, an expiration date, a or a Health Industry Bar Code (HIBCC) or a Global Trade Item Number.

4. The system of claim 1, further comprising a voice assistant module configured to receive voice commands through the microphone and provide audio responses through the speaker, wherein the voice assistant module is configured to process natural language commands related to inventory management tasks.

5. The system of claim 1, wherein the voice assistant module is configured to interpret natural language commands for adding items to the inventory database, removing items from the inventory database, checking expiration dates of items, and locating items within a facility.

6. The system of claim 1, wherein the voice assistant module is configured to operate in an online mode utilizing server-based processing and an offline mode utilizing local processing capabilities of the mobile computing device.

7. The system of claim 1, wherein the backend processing system is configured to retrieve a location identifier corresponding to a queried bin number and provide the location identifier in a condensed alphanumeric format or an expanded descriptive textual format.

8. The system of claim 1, further comprising a notification system configured to generate visual alerts on the display and audible alerts through the speaker to notify a user of inventory events comprising at least one of approaching expiration dates, low stock levels, or successful data entries.

9. The system of claim 1, further comprising an augmented reality interface configured to overlay visual indicators on the display, wherein the visual indicators comprise at least one of inventory level indicators, expiration status indicators, or directional guidance to a storage location.

10. The system of claim 9, wherein the augmented reality interface is configured to color-code items based on expiration status.

11. The system of claim 1, wherein the artificial intelligence engine is configured to analyze inventory data and provide context-based recommendations for inventory actions comprising at least one of adjusting stock levels, reordering items, or relocating items based on usage patterns.

12. The system of claim 1, further comprising a user account management module configured to associate each user with a set of permissions, notification preferences, and activity logs.

13. A method for managing inventory, the method comprising:
capturing, by a camera of a mobile computing device, an image of a product label associated with an inventory item;
processing, by an optical character recognition engine, the image to extract product information from the product label;
cross-referencing the extracted product information with entries stored in an inventory database;
receiving, by a voice assistant module, a voice command related to an inventory management action for the inventory item;
processing, by the voice assistant module, the voice command using natural language processing to determine the inventory management action; and
updating the inventory database based on the inventory management action.

14. The method of claim 13, further comprising:
displaying, on a user interface of the mobile computing device, the extracted product information for user verification; and
receiving, through the user interface, a confirmation input from a user prior to updating the inventory database.

15. The method of claim 13, further comprising:
scanning, by the camera, a machine-readable code on a location label to retrieve a location identifier; and
associating the extracted product information with the location identifier in the inventory database.

16. The method of claim 15, wherein the location identifier comprises a floor number, a room number, a storage type, a row number, and a positional reference, and wherein a bin number is derived from the location identifier.

17. The method of claim 13, further comprising:
receiving, by the voice assistant module, a voice query requesting a location of a specified item;
retrieving, from the inventory database, location information associated with the specified item; and
providing, by the voice assistant module, an audio response comprising the location information.

18. The method of claim 13, further comprising:
displaying, on the mobile computing device, an augmented reality overlay indicating at least one of an expiration status, an inventory level, or a directional guide to a storage location associated with the inventory item.

19. The method of claim 13, further comprising:
providing, by the mobile computing device, an audible confirmation upon completion of the inventory management action.

20. A non-transitory computer-readable medium storing instructions that, when executed by a processor, cause the processor to:
receive image data captured by a camera of a mobile computing device, wherein the image data comprises an image of a label associated with an inventory item;
process the image data using optical character recognition to extract textual information from the label;
receive a voice command through a microphone of the mobile computing device;
process the voice command using natural language processing to identify an inventory management action;
update an inventory database based on the inventory management action and the extracted textual information; and
provide feedback to a user through at least one of a display or a speaker of the mobile computing device indicating completion of the inventory management action.
